(19) United States
(12) Patent Application Publication
(10) Pub. No.: US 2024/0077720 A1
(43) Pub. Date: Mar. 7, 2024

(54) OPTICAL DEVICE FOR AUGMENTED REALITY CAPABLE OF PROVIDING EXPANDED EYEBOX THROUGH POLARIZATION

(71) Applicant: LETINAR CO., LTD, Anyang-si (KR)

(72) Inventors: Jeong Hun HA, Seoul (KR); Kwang Bok LEE, Suwon-si (KR)

(73) Assignee: LETINAR CO., LTD, Anyang-si (KR)

(21) Appl. No.: 18/451,298

(22) Filed: Aug. 17, 2023

(30) Foreign Application Priority Data
Sep. 2, 2022 (KR) 10-2022-0111404

(51) Int. Cl. G02B 27/01; G06T 19/00

(52) U.S. Cl. CPC G02B 27/0101; G06T 19/006

(57) ABSTRACT

Disclosed herein is an optical device for augmented reality capable of providing an expanded eyebox through polarization. The optical device for augmented reality includes: an image output unit configured to output a first virtual image light polarized in a first direction and a second virtual image light polarized in a second direction; an optical means configured to transmit real object image light therethrough to the pupil of an eye of a user; a first optical element disposed in the optical means, and configured to provide a first virtual image by transferring only the first one of the first and second virtual image lights to the pupil of the user; and a second optical element disposed in the optical means, and configured to provide a second virtual image by transferring only the second one of the first and second virtual image lights to the pupil of the user.

### CROSS-REFERENCE TO RELATED APPLICATION

This application claims the benefit of Korean Patent Application No. 10-2022-0111404 filed on Sep. 2, 2022, which is hereby incorporated by reference herein in its entirety.

### BACKGROUND

### 1. Technical Field

The present invention relates to an optical device for augmented reality, and more particularly, to an optical device for augmented reality capable of providing an expanded eyebox and field of view (FOV) through polarization.

### 2. Description of the Related Art

Augmented reality (AR) refers to technology that superimposes a virtual image, provided by a computer or the like, on a real image in the real world and then provides a resulting image, thereby providing “augmented” virtual image information to a user, as is well known.

An apparatus for realizing such augmented reality requires an optical combiner that enables the simultaneous observation of virtual images and real images of the real world. As such optical combiners, there are known half mirror-type combiners and holographic/diffractive optical element (HOE/DOE)-type combiners.

Half mirror-type combiners have problems in that the transmittance of virtual images is low and it is difficult to provide a comfortable fit because the volume and weight thereof are increased to provide a wide FOV. In order to reduce the volume and weight, there have also been proposed technologies such as Light-guide Optical Element (LOE), which requires a plurality of small half-mirrors to be disposed inside a waveguide. This technology also has limitations in that the manufacturing process is complicated because the image light of a virtual image needs to pass through the half-mirrors a number of times inside the waveguide and in that luminous uniformity may easily be lowered due to manufacturing errors.

In addition, HOE/DOE-type combiners generally employ nanostructure gratings or diffraction gratings. Since they are manufactured in a significantly precise process, the technology has limitations in that the manufacturing cost is high and the yield for mass production is low. Furthermore, due to the difference in diffraction efficiency according to the wavelength band and the incident angle, this technology has limitations in terms of color uniformity and the low sharpness of an image. Holographic/diffractive optical elements are often used in conjunction with waveguides as in the LOEs described above. Accordingly, this technology still has the same problems.

Furthermore, the conventional optical combiners have limitations in that a virtual image is out of focus when a user changes a focal length when gazing at the real world. In order to overcome this problem, there has been proposed a technology using a prism capable of adjusting the focal length of a virtual image or a variable focus lens capable of electrically controlling the focal length. However, these technologies also has a problem in that a user needs to perform a separate operation to adjust the focal length and also separate hardware and software are required for controlling the focal length.

In order to overcome the problems of the prior art, the present applicant has developed a technology that projects a virtual image onto the retina through the pupil by using a reflective unit in the form of a pin mirror having a smaller size than the human pupil (see Korean Patent Application Publication No. 10-2018-0028339 (hereinafter referred to as “patent document 1”) published on Mar. 16, 2018).

FIG. 1 is a diagram showing an optical device 100 for augmented reality as disclosed in patent document 1.

The optical device 100 for augmented reality shown in FIG. 1 includes an optical means 10, a reflective unit 20, and an image output unit 30.

The image output unit 30 is a means for outputting virtual image light. For example, the image output unit 30 may include a micro-display unit configured to display a virtual image on a screen and output virtual image light corresponding to the displayed virtual image, and a collimator configured to collimate the image light, output from the micro-display unit, into parallel light.

The optical means 10 is a means for serving to transmit real object image light, which is image light output from an object in the real world, therethrough to the pupil 40 and output the virtual image light, which is reflected by the reflective unit 20, to the pupil 40.

The optical means 10 may be made of, e.g., a transparent resin material like a glasses lens, and may be fixed by a frame (not shown) such as a glasses frame.

The reflective unit 20 is a means for transferring the virtual image light, output from the image output unit 30, toward a pupil 40 of a user by reflecting the virtual image light.

The reflective unit 20 is embedded and disposed inside the optical means 10.

The reflective unit 20 of FIG. 1 is formed to have a smaller size than a human pupil. Since it is known that the average size of the pupil of people is about 4 to 8 mm, the reflective unit 20 is preferably formed to have a size of 8 mm or less, more preferably 4 mm or less.

By forming the reflective unit 20 to be smaller than the average pupil as described above, the depth of field for light entering the pupil through the reflective unit 20 may be made almost infinite, i.e., considerably deep.

In this case, the depth of field refers to a range within which an image for augmented reality is recognized as being in focus. As the depth of field increases, the range of focal lengths for virtual images widens correspondingly. Accordingly, even when a user changes the focal length for the real world while gazing at the real world, the user always recognizes an image for augmented reality as being in focus regardless of such a change. This may be viewed as a type of pinhole effect.

Accordingly, even when the user changes the focal length for a real object, the user may always observe a clear virtual image.

FIGS. 2 to 4 are views showing an optical device 200 for augmented reality as disclosed in Korean Patent No. 10-2192942 (hereinafter referred to as “patent document 2”) published on Dec. 18, 2020, in which FIG. 2 is a side view thereof, FIG. 3 is a perspective view thereof, and FIG. 4 is a front view thereof.

The optical device 200 for augmented reality shown in FIGS. 2 to 4 has the same basic principle as the optical device 100 for augmented reality shown in FIG. 1. However, the optical device 200 for augmented reality is different from the optical device 100 for augmented reality in that a reflective unit 20 includes a plurality of reflective modules and is disposed inside the optical means 10 in the form of an array in order to widen the eyebox and FOV thereof and the virtual image light output from an image output unit 30 is reflected by total internal reflection on an inner surface of the optical means 10 and then transferred to the reflective unit 20.

In FIGS. 2 to 4, reference numerals 21 to 26 denote only reflective modules viewed from a side as shown in FIG. 2, and the reflective unit 20 collectively denotes all the plurality of reflective modules.

As described above, each of the plurality of reflective modules is preferably formed to have a size of 8 mm or less, more preferably 4 mm or less.

In FIGS. 2 to 4, the virtual image light output from the image output unit 30 is reflected by total internal reflection on the inner surface of the optical means 10 and then transferred to the reflective modules 21 to 26, and the reflective modules 21 to 26 transfers the incident virtual image light to the pupil 40 by reflecting the incident virtual image light.

Accordingly, the reflective modules 21 to 26 need to be disposed to have appropriate inclination angles inside the optical unit 10 as shown in the drawing by taking into consideration the positions of the image output unit 30 and the pupil 40.

Compared to the optical device 100 for augmented reality shown in FIG. 1, the optical device 200 for augmented reality has the advantage of widening the eyebox and FOV thereof. However, in order to widen the eyebox and FOV of the optical device 200 for augmented reality, the image output unit 30 needs to be larger and a larger number of reflective modules need to be disposed in the vertical axis direction. Therefore, problems arise in that form factors such as size, weight, and volume increase, design is difficult, and manufacturing is not easy.

### SUMMARY

The present invention has been conceived to overcome the above-described problems, and an object of the present invention is to provide an optical device for augmented reality capable of providing an expanded eyebox and FOV through polarization.

Another object of the present invention is to provide an optical device for augmented reality capable of expanding the eyebox and FOV thereof that is easy to design and manufacture while reducing form factors by using a smaller number of optical combiners without increasing the size of an image output unit.

According to an aspect of the present invention, there is provided an optical device for augmented reality capable of providing an expanded eyebox through polarization, the optical device including: an image output unit configured to output a first virtual image light polarized in a first direction and a second virtual image light polarized in a second direction; an optical means configured to transmit real object image light, output from a real object, therethrough and transfer the real object image light to the pupil of an eye of a user; a first optical element disposed in the optical means, and configured to provide a first virtual image by transferring only the first one of the first and second virtual image lights, output from the image output unit, to the pupil of the eye of the user; and a second optical element disposed in the optical means, and configured to provide a second virtual image by transferring only the second one of the first and second virtual image lights, output from the image output unit, to the pupil of the eye of the user.

The first and second virtual images may be virtual images that are obtained by dividing one single virtual image into upper and lower portions.

The image output unit may alternately output the first virtual image light polarized in the first direction and the second virtual image light polarized in the second direction at preset time intervals.

The first optical element may be formed of a polarization reflection means configured to reflect only the first virtual image light polarized in the first direction and transfer only the first virtual image light to the pupil and to absorb or transmit, therethrough, virtual image light in directions other than the first direction; and the second optical element may be formed of a polarization reflection means configured to reflect only the second virtual image light polarized in the second direction and transfer only the second virtual image light to the pupil and to absorb or transmit, therethrough, virtual image light in directions other than the second direction.

The first and second optical elements may each include one or more optical modules that each have a size of 4 mm or less and are spaced apart from each other.

The first and second optical elements may each be disposed at an inclination angle in the optical means in order to transfer a corresponding one of the first and second virtual image lights, output from the image output unit, to the pupil of the eye of the user.

The first and second optical elements may each be disposed to have an inclination angle with respect to a vertical line perpendicular to a forward direction from the pupil when the optical device for augmented reality is placed in front of the pupil and viewed from a side.

The inclination angles that the first and second optical elements have with respect to the vertical line perpendicular to the forward direction from the pupil may be different from each other.

The first and second optical elements may be sequentially and alternately disposed along a direction away from the image output unit.

The inclination angles of the first and second optical elements may be set such that the first and second virtual images provided by one pair of adjacent first and second optical elements constitute one single image.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram showing an optical device for augmented reality as disclosed in patent document 1;

FIGS. 2 to 4 are views showing an optical device for augmented reality as disclosed in patent document 2, in which FIG. 2 is a side view thereof, FIG. 3 is a perspective view thereof, and FIG. 4 is a front view thereof;

FIGS. 5 to 7 are views showing an optical device for augmented reality capable of providing an expanded eyebox through polarization according to the present invention, in which FIG. 5 is a perspective view thereof, FIG. 6 is a front view thereof, and FIG. 7 is a side view thereof;

FIG. 8 is a diagram illustrating an eyebox and an FOV in the conventional optical device shown in FIGS. 2 to 4;

FIGS. 9 and 10 are diagrams illustrating an eyebox and an FOV in the optical device for augmented reality according to the present invention; and

FIG. 11 shows the cases of FIGS. 9 and 10 together.

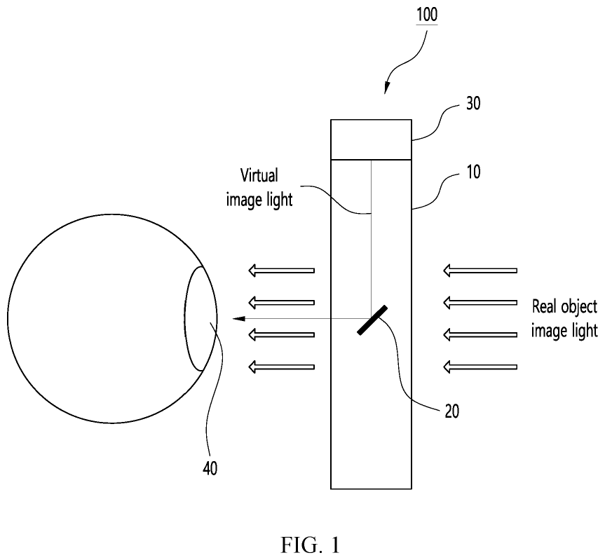

### DETAILED DESCRIPTION

Embodiments of the present invention will be described in detail below with reference to the accompanying drawings.

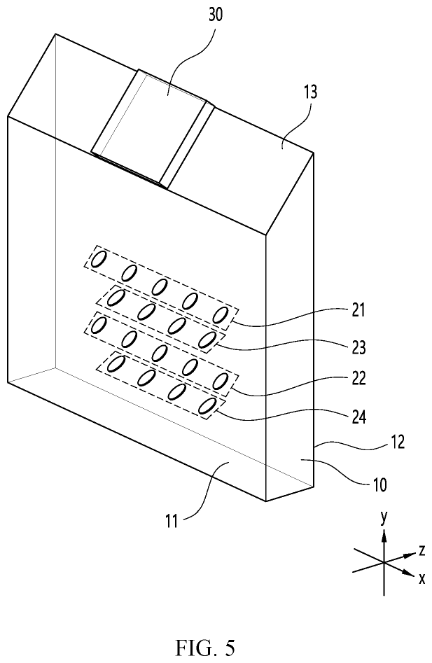

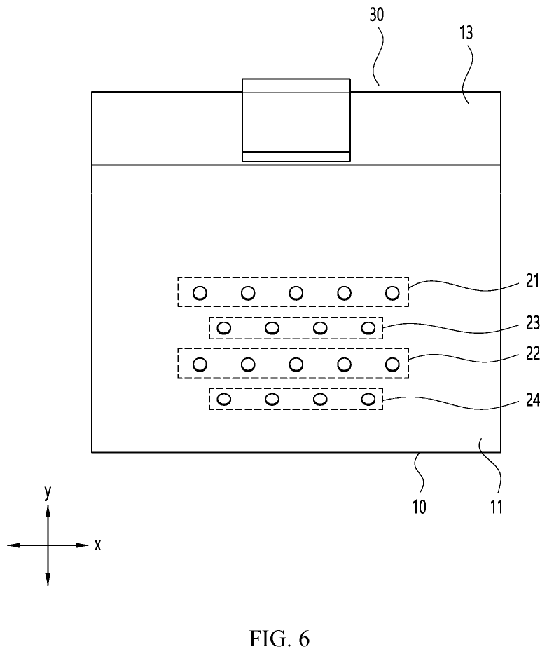

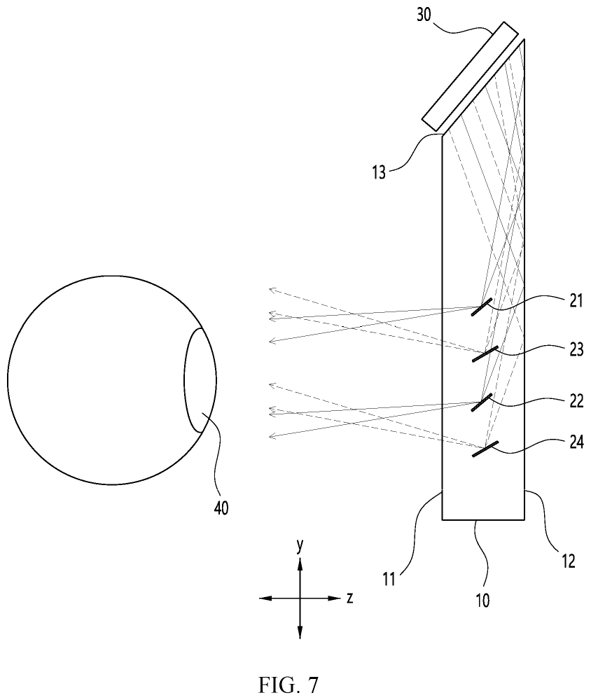

FIGS. 5 to 7 are views showing an optical device 300 for augmented reality capable of providing an expanded eyebox through polarization according to the present invention, in which FIG. 5 is a perspective view thereof, FIG. 6 is a front view thereof, and FIG. 7 is a side view thereof.

Referring to FIGS. 5 to 7, the optical device 300 for augmented reality capable of providing an expanded eyebox through polarization (hereinafter simply referred to as the “optical device 300”) includes an image output unit 30, an optical means 10, first optical elements 21 and 22, and second optical elements 23 and 24.

The image output unit 30 is a means for outputting virtual image light, which is image light corresponding to a virtual image. Here, the virtual image refers to an image for augmented reality provided to a user, and may be a still image or a moving image.

The image output unit 30 may include a micro-display unit configured to display a virtual image, such as a conventionally known small-sized LCD, OLED, LCoS, and micro LED display, or the like, and a light conversion unit configured to transfer the image light, output from the micro-display unit, to the first and second optical elements 21 to 24.

In this case, the light conversion unit is a means for allowing virtual image light to be output along an intended optical path and focal length. For example, the light conversion unit may be an optical element such as a convex lens configured to refract and outputs incoming virtual image light in order to magnify a virtual image or a collimator configured to convert incident light into parallel light and output the parallel light.

Meanwhile, the image output unit 30 outputs a first virtual image light polarized in a first direction and a second virtual image light polarized in a second direction.

In this case, the first virtual image light is an image light corresponding to a first virtual image, and the second virtual image light is an image light corresponding to a second virtual image.

The first and second virtual images are preferably different virtual images, and may be, e.g., two virtual images obtained by dividing one single virtual image into upper and lower portions. It is obvious that alternatively, the first and second virtual images may be the same virtual images.

The first virtual image light is the image light polarized in the first direction, i.e., virtual image light having only a polarization component in the first direction out of the virtual image light. The second virtual image light is the image light polarized in the second direction, i.e., virtual image light having only a polarization component in the second direction out of the virtual image light.

The first and second directions are preferably perpendicular to each other. For example, when the first virtual image light is s-polarized light, the second virtual image light may be p-polarized light.

The image output unit 30 may alternately output the first virtual image light polarized in the first direction and the second virtual image light polarized in the second direction at preset time intervals.

For example, when displaying a virtual image at a frame rate of 60 frames per second, the image output unit 30 may alternately output the first and second virtual image lights each at a rate of 30 times per second.

The micro-display unit itself of the image output unit 30 may output the first virtual image light polarized in the first direction and the second virtual image light polarized in the second direction. Alternatively, for example, the first and second virtual image lights may be alternately output in such a manner that the image out unit 30 outputs non-polarized first virtual image light and non-polarized second virtual image light and two polarizers and shutters configured to output polarized light in the first direction and polarized light in the second direction respectively are disposed in the micro-display unit and appropriately controlled.

This technology itself is known in prior art, and it is obvious that methods other than this method may be employed. Furthermore, since this is not a direct target of the present invention, a detailed description thereof will be omitted.

The first and second virtual image lights output from the image output unit 30 are transferred to the first optical elements 21 and 22 or the second optical elements 23 and 24.

The optical means 10 is a means for transferring the real object image light, output from a real object present in the real world, to the pupil 40 of an eye of a user by transmitting the real object image light therethrough. Furthermore, the first and second virtual image lights output from the first and second optical elements 21 to 24 are transferred to the pupil 40 through the optical means 10.

The optical means 10 has a first surface 11 through which the first and second virtual image lights and the real object image light are output toward the pupil 40 of the user, a second surface 12 which is opposite to the first surface 11 and on which the real object image light is incident, and a third surface 13 on which the image output unit 30 is disposed.

The optical means 10 may be made of a transparent resin or glass material.

The first optical elements 21 and 22 are means that are disposed in the optical means 10 and provide the first virtual image by transferring only the first virtual image light of the first and second virtual image lights, output from the image output unit 30, to the pupil 40 of the eye of the user.

The first optical elements 21 and 22 may be formed of polarization reflection means configured to transfer only the first virtual image light polarized in the first direction to the pupil 40 by reflecting the first virtual image light and prevent virtual image light in directions other than the first direction from being transferred to the pupil 40 by absorbing or transmitting the virtual image light in other directions. Accordingly, the first optical elements 21 and 22 do not transfer the second virtual image light polarized in the second direction to the pupil 40.

Although the first optical elements 21 and 22 are preferably embedded inside the optical means 10, they may be disposed inside or outside the first surface 11 or second surface 12 of the optical means 10.

The second optical elements 23 and 24 are means that are disposed in the optical means 10 and provide the second virtual image by transferring only the second virtual image light of the first and second virtual image lights, output from the image output unit 30, to the pupil 40 of the eye of the user.

The second optical elements 23 and 24 may be formed of polarization reflection means configured to transfer only the second virtual image light polarized in the second direction to the pupil 40 by reflecting the second virtual image light and prevent virtual image light in directions other than the second direction from being transferred to the pupil 40 by absorbing or transmitting the virtual image light in other directions. Accordingly, the second optical elements 23 and 24 do not transfer the first virtual image light polarized in the first direction to the pupil 40.

Although the second optical elements 23 and 24 are also preferably embedded inside the optical means 10, they may be disposed inside or outside the first surface 11 or second surface 12 of the optical means 10.

Each of the first optical elements 21 and 22 and the second optical elements 23 and 24 may be composed of at least one optical module.

The optical module may be formed to have a size smaller than the average size of the pupil of people, i.e., 8 mm or less, preferably 4 mm or less, in order to achieve a pinhole effect by increasing the depth of field.

By this, the depth of field for light entering the pupil may be made considerably deep. Accordingly, there may be achieved a pinhole effect in which even when a user changes the focal length for the real world while gazing at the real world, the user always recognizes a virtual image as being in focus regardless of such a change.

In this case, the size of the optical module is defined as the maximum length between any two points on the edge boundary of the optical module.

Furthermore, the size of the optical module may be the maximum length between any two points on the edge boundary of the orthogonal projection of the optical module projected onto a plane including the center of the pupil 40 while being perpendicular to a straight line between the pupil 40 and the optical module.

However, since a diffraction phenomenon increases when the size of the optical module is excessively small, it is preferable to make the size of the optical module larger than, e.g., 0.3 mm.

Furthermore, the shape of the optical module may be circular.

Moreover, the optical module may be formed in an elliptical shape so that the optical module appears circular when viewed from the pupil 40.

When each of the first optical elements 21 and 22 is composed of a plurality of optical modules, i.e., two or more optical modules, the plurality of optical modules may be spaced apart from each other and arranged in a horizontal direction when the optical device 300 is placed in front of the pupil 40 and viewed from the pupil 40 as an example, as shown in FIG. 6. This also applies to the second optical elements 23 and 24.

In the case where each of the first and second optical elements 21 to 24 is composed of a plurality of optical modules, when the optical device 300 is placed in front of the pupil 40 and viewed from the pupil 40, the plurality of optical modules may be spaced apart from each other and arranged in an array form.

As optical modules are spaced apart from each other and arranged in this manner, real object image light may be transferred to the pupil 40 through the spaces between them, and virtual image light is transferred to the pupil 40 through the first and second optical elements 21 to 24 and, so that a user may receive augmented reality service.

Although in the optical device 300 of FIGS. 5 to 7, there are illustrated two first optical elements 21 and 22 each composed of five optical modules and two second optical elements 21 to 24 each composed of four optical modules, this is an example. It is obvious that one first optical element or two or more first optical elements and one second optical element or two or more second optical elements may be provided.

The first optical elements 21 and 22 and the second optical elements 23 and 24 may be disposed to be inclined inside the optical means 10 in order to transfer the first and second virtual image lights, output from the image output unit 30, to the pupil 40 of an eye of the user.

In this case, the first optical elements 21 and 22 and the second optical elements 23 and 24 may each be disposed in the optical means 10 to have an appropriate inclination angle by taking into consideration the relative positions of the image output unit 30 and the pupil 40.

In the embodiment of FIGS. 5 to 7, the first and second virtual image lights output from the image output unit 30 are reflected by total internal reflection on the second surface 12 of the optical means 10 and then transferred to the first optical element 21 and 22 or the second optical elements 23 and 24.

Accordingly, the first optical elements 21 and 22 and the second optical elements 23 and 24 may be disposed to be inclined inside the optical means 10 in order to transfer the first and second virtual image lights, reflected by total internal reflection on the second surface 12 of the optical means 10 and then transferred, to the pupil 40.

For example, the first optical elements 21 and 22 and the second optical elements 23 and 24 may each be disposed to have an inclination angle with respect to a vertical line perpendicular to a forward direction from the pupil 40 when the optical device 300 is placed in front of the pupil 40 and viewed from a side, as shown in FIG. 7.

In this case, the first optical elements 21 and 22 and the second optical elements 23 and 24 may be disposed to be closer to the second surface 12 of the optical means 10 as the distance from the image output unit 30 thereto is increased, in order not to block the virtual image light that is output from the image output unit 30 and then transferred to other first optical elements 21 and 22 or other second optical elements 23 and 24.

However, it is preferable that the first optical elements 21 and 22 and the second optical elements 23 and 24 are disposed to have different inclination angles with respect to the vertical line perpendicular to the forward direction from the pupil 40.

In this case, it is preferable that the inclination angles of the first optical elements 21 and 22 and the second optical elements 23 and 24 are set such that the first and second virtual images provided by each pair of adjacent first and second optical elements 21 and 23, or 22 and 24 constitute one single image, as shown in FIG. 11.

Meanwhile, it is preferable that the inclination angles of the first optical elements 21 and 22 are equal to each other and the inclination angles of the optical modules constituting the first optical elements 21 and 22 are equal to each other. However, this may vary somewhat depending on the design and requirements. This also applies to the second optical elements 23 and 24.

In addition, the first optical elements 21 and 22 and the second optical elements 23 and 24 are sequentially and alternately disposed in a direction away from the image output unit 30 when the optical device 300 is viewed from the side, as shown in FIG. 7.

Next, the operating principle of the first optical elements 21 and 22 and the second optical elements 23 and 24 will be described.

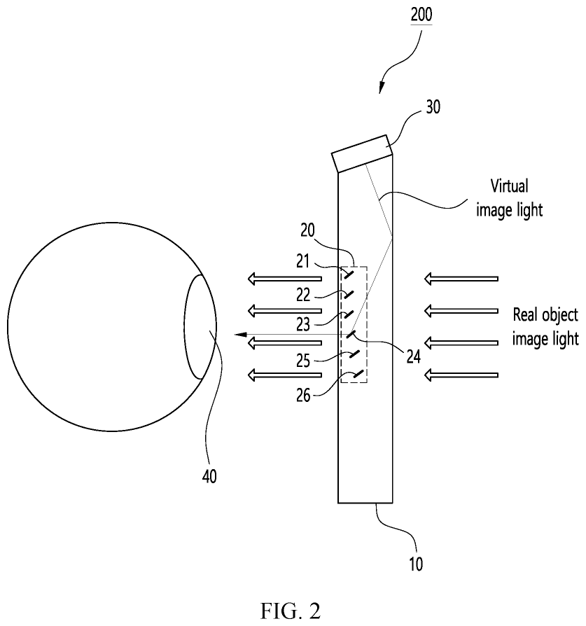

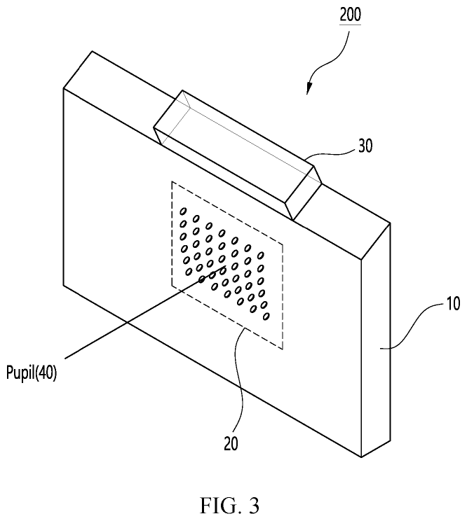

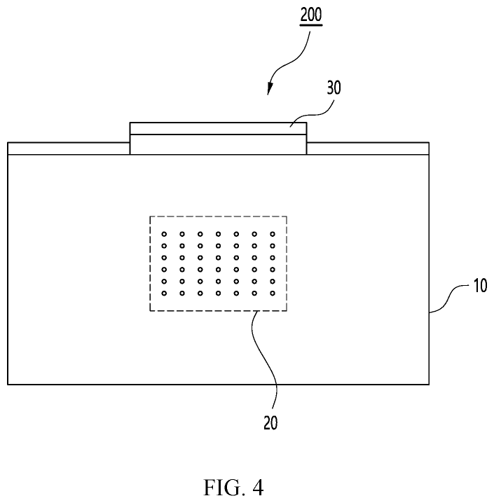

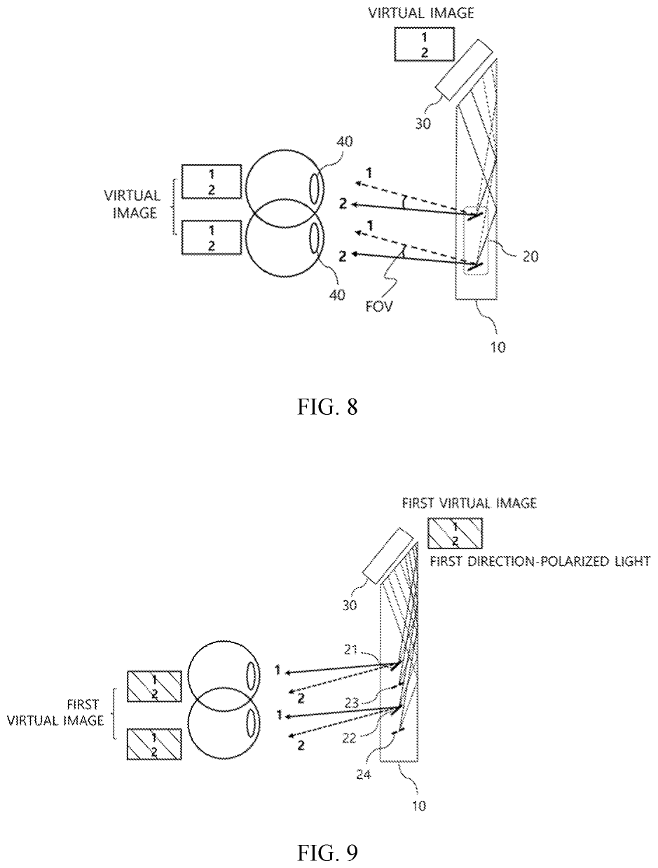

FIG. 8 is a diagram illustrating an eyebox and an FOV (Field of View) in the conventional optical device 200 shown in FIGS. 2 to 4.

As shown in FIG. 8, virtual image light 1 and virtual image light 2 corresponding to a virtual image output from the image output unit 30 are reflected by the reflective unit 20 and then transferred to the pupil 40.

In this case, assuming that the number “1” is disposed in the upper portion of the virtual image and the number “2” is disposed in the lower portion of the virtual image as shown in FIG. 8, virtual image light 1 is virtual image light corresponding to the number “1,” i.e., the upper portion of the virtual image, and virtual image light 2 is virtual image light corresponding to the number “2,” i.e., the lower portion of the virtual image.

The virtual image light 1 indicated by the dotted line is reflected by the reflective unit 20 and then transferred to the pupil 40 and the virtual image light 2 indicated by the solid line is reflected by the reflective unit 20 and then transferred to the pupil 40, so that it can be seen that the FOV is determined by the angles between the virtual image light 1 and the virtual image light 2, as shown in FIG. 8.

FIG. 9 is a side view of the optical device 300 according to the present invention when the image output unit 30 outputs a first virtual image light corresponding to a first virtual image which illustrates an eyebox and an FOV in the optical device 300.

As shown in FIG. 9, the number “1” is disposed in the upper portion of the first virtual image and the number “2” is disposed in the lower portion of the first virtual image.

Further, virtual image light 1 is virtual image light corresponding to the number “1,” i.e., the upper portion of the first virtual image, and virtual image light 2 is virtual image light corresponding to the number “2,” i.e., the lower portion of the first virtual image.

As described above, the second optical elements 23 and 24 do not transfer the first virtual image light polarized in the first direction to the pupil 40, so that the first virtual image light is transferred to the pupil 40 only by the first optical elements 21 and 22.

Accordingly, in the case of FIG. 9, a user recognizes the first virtual image transferred by the first optical elements 21 and 22.

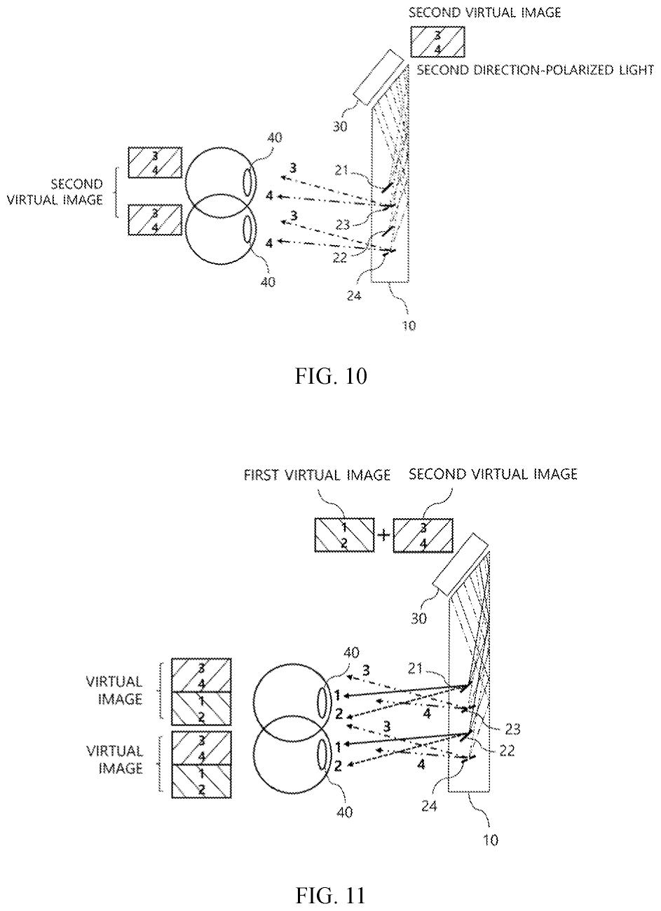

FIG. 10 is a side view of the optical device 300 according to the present invention when the image output unit outputs a second virtual image light corresponding to a second virtual image which illustrates an eyebox and an FOV in the optical device 300.

As shown in FIG. 10, the number “3” is disposed in the upper portion of the second virtual image and the number “4” is disposed in the lower portion of the second virtual image. Further, virtual image light 3 is virtual image light corresponding to the number “3,” i.e., the upper portion of the second virtual image, and virtual image light 4 is virtual image light corresponding to the number “4,” i.e., the lower portion of the second virtual image.

Furthermore, as described above, the first and second virtual images may be virtual images obtained by dividing one single virtual image into upper and lower portions, and the second virtual image may be a segment image over the first virtual image.

As described above, the first optical elements 21 and 22 do not transfer the second virtual image light polarized in the second direction to the pupil 40, so that the second virtual image light is transferred to the pupil 40 only by the second optical elements 23 and 24.

Accordingly, in the case of FIG. 10, a user recognizes the second virtual image transferred by the second optical elements 23 and 24.

FIG. 11 shows the cases of FIGS. 9 and 10 together.

When the image output unit 30 alternately outputs the first virtual image light polarized in the first direction and the second virtual image light polarized in the second direction as described above, the first and second virtual images can be provided alternately to a user according to the principles described in conjunction with FIGS. 9 and 10.

In this case, as each of the intervals at which the first and second virtual image lights are alternately output decreases, the user recognizes the first and second virtual images as being simultaneously provided.

Accordingly, the first virtual image and the second virtual images are provided with being disposed in upper and lower portions as shown on the left side of FIG. 11 and it can be seen that the eyebox and FOV in this case are significantly enlarged compared to those of FIG. 8.

While the present invention has been described with reference to the embodiments according to the present invention, this is illustrative. It should be noted that all modifications within the range of equivalents determined by the appended claims and drawings are included in the scope of the present invention.

Although the first and second virtual image lights are described as being transferred to the first or second optical elements 21 and 22, or 23 and 24 by total internal reflection inside the optical means 10 in the above embodiments as an example, it is obvious that they may be transferred to the first or second optical elements 21 and 22, or 23 and 24 without total internal reflection or through two or more total internal reflections.

According to the present invention, there is provided the optical device for augmented reality capable of providing an expanded eyebox and FOV through polarization.

In particular, according to the present invention, there is provided the optical device for augmented reality capable of expanding the eyebox and FOV thereof that is easy to design and manufacture while reducing form factors by using a smaller number of optical combiners without increasing the size of an image output unit.

What is claimed is:

1. An optical device for augmented reality capable of providing an expanded eyebox through polarization, the optical device comprising:
an image output unit configured to output a first virtual image light polarized in a first direction and a second virtual image light polarized in a second direction;
an optical means configured to transmit real object image light, output from a real object, therethrough and transfer the real object image light to a pupil of an eye of a user;
a first optical element disposed in the optical means, and configured to provide a first virtual image by transferring only the first virtual image lights, output from the image output unit, to the pupil of the eye of the user; and
a second optical element disposed in the optical means, and configured to provide a second virtual image by transferring only the second virtual image lights, output from the image output unit, to the pupil of the eye of the user.

2. The optical device of claim 1, wherein the first and second virtual images are virtual images that are obtained by dividing one single virtual image into upper and lower portions.

3. The optical device of claim 1, wherein the image output unit alternately outputs the first virtual image light polarized in the first direction and the second virtual image light polarized in the second direction at preset time intervals.

4. The optical device of claim 1, wherein:
the first optical element is formed of a polarization reflection means configured to reflect only the first virtual image light polarized in the first direction and transfer only the first virtual image light to the pupil and to absorb or transmit, therethrough, virtual image light in directions other than the first direction; and
the second optical element is formed of a polarization reflection means configured to reflect only the second virtual image light polarized in the second direction and transfer only the second virtual image light to the pupil and to absorb or transmit, therethrough, virtual image light in directions other than the second direction.

5. The optical device of claim 1, wherein each of the first and second optical elements include one or more optical modules that have a size of 4 mm or less and are spaced apart from each other.

6. The optical device of claim 1, wherein the first and second optical elements are each disposed at an inclination angle in the optical means in order to transfer a corresponding one of the first and second virtual image lights, output from the image output unit, to the pupil of the eye of the user.

7. The optical device of claim 6, wherein the first and second optical elements are each disposed to have an inclination angle with respect to a vertical line perpendicular to a forward direction from the pupil when the optical device for augmented reality is placed in front of the pupil and viewed from a side.

8. The optical device of claim 7, wherein the inclination angles that the first and second optical elements have with respect to the vertical line perpendicular to the forward direction from the pupil are different from each other.

9. The optical device of claim 8, wherein the first and second optical elements are sequentially and alternately disposed along a direction away from the image output unit.

10. The optical device of claim 9, wherein the inclination angles of the first and second optical elements are set such that the first and second virtual images provided by one pair of adjacent first and second optical elements constitute one single image.
